(19) United States
(12) Patent Application Publication
(10) Pub. No.: US 2018/0317572 A1
(43) Pub. Date: Nov. 8, 2018

(54) PERSONAL AIR-CONDITIONING SYSTEM

(71) Applicant: ENTROSYS LTD., Tel-Aviv (IL)

(72) Inventors: Glen David GUTTMAN, Tel-Aviv (IL); Lev AHARONI, Jerusalem (IL)

(21) Appl. No.: 15/740,615

(22) PCT Filed: Jun. 23, 2016
(86) PCT No.: PCT/IL2016/050668

§ 371 Date: Dec. 28, 2017

(30) Foreign Application Priority Data
Jul. 1, 2015 (IL) 239738

(51) Int. Cl. A41D 13/002; A41D 13/005; A41D 27/28; B60N 2/56

(52) U.S. Cl. CPC A41D 13/0025; A41D 13/0051; F24F 2221/38; B60N 2/5621; A41D 2400/60; A41D 27/28

(57) ABSTRACT

A personal air-conditioning system and method of operating thereof are described. The system includes an air moving device operable to provide an air stream, a flexible ventilation section being in air flow communication with said air moving device and a control unit coupled to said air moving device for controlling operation thereof. The flexible ventilation section is in the form of a multi-layered structure and configured to provide the air stream to a user of the personal air-conditioning system.

### FIELD OF THE INVENTION

This invention relates generally to air-conditioning systems for personal and individual use, and in particular to any garments or any items of apparel that provide heating or cooling to the user of the air-conditioning systems.

### BACKGROUND OF THE INVENTION

It is generally recognized that ability of a person to accurately and efficiently perform assigned tasks perform efficiently, depend, inter alia, on the weather conditions of the environment in which the person has to operate. A major problem in hot weather conditions is heat fatigue. One of the thermoregulation mechanisms of the human body in hot conditions is perspiration. Perspiration, due to activity of the sweat glands, is especially active during and after exertion. Evaporation of sweat exuded by the sweat glands has a cooling effect. Moreover, an item of apparel worn by a person can provide a thermal and physical barrier, and thereby retard the dissipation of heat and perspiration from the body of the person. This may cause the body to overheat and thereby degrade the wearer's performance. Furthermore, moisture remaining on the body, due to perspiration after exertion, provides an ideal environment for various fungi and microorganisms, which can lead to odors, skin rashes and other irritations and diseases.

In reverse conditions, cold weather can also decrease a person's efficiency to perform certain functions (due to cold fatigue). Thus, in cold climates, a person has to wear coats, jackets and/or multiple layers of clothing in order to be in a comfortable environment.

Various individual heating, ventilation and air-conditioning (HVAC) air-conditioning systems are known in the art which are used in conjunction with different garments to meet the demands of the two different weather conditions. The basic approach for temperature regulation of the human body is based on employment and exploitation of two main thermoregulation mechanisms that the body uses to cool itself, such as evaporation and convection. The convection mechanism includes external cooling/heating of blood flow within the user's skin, and internal convection to the blood vessels of the lungs. Systems are known in the art that provide airflow in order to evaporate sweat, thus cooling the body. The cool air provided by the system can pump heat from blood vessels on the surface of the body, reducing the body's core temperature. In turn, the heated air can provide thermoregulation mainly by convection.

For example, U.K. Patent Application GB2106318 to Douglas et al. describes a light-weight heat exchanger for use with a fluid conditioning garment. The heat exchanger includes a thermoelectric module array based on the Peltier effect and adapted to be connected to a suitable power source. The heat exchanger also includes a fluid duct in thermally conducting association with the cold junctions of the array, a gas duct in thermally conducting association with the hot junctions of the array and a fan for causing gas to pass in the gas duct. The fluid duct is adapted for connection to a fluid conditioning garment. The heat sink may incorporate a fluid pump for pumping fluid through the fluid duct.

U.S. Pat. No. 4,649,715 to Barker describes an apron including a built-in air conditioner for heating, cooling or ventilating the apron as desired by the person wearing the apron. The apron has an internal apron pocket. An air conditioner including an air blower is mounted within the apron pocket. The air conditioner includes an air duct for conveying air discharged by the blower to the apron pocket and/or to the atmosphere outside the apron. This air duct has a first exit extending outside of the apron through an apron opening, and a second exit within the apron pocket. The flow of air through the first duct exit is selectively controlled to thereby direct flow of air as desired through the second duct exit and into the apron pocket. In this way, the apron pocket may be heated, cooled or ventilated to the extent desired.

U.S. Pat. No. 4,914,752 to Hinson et al. describes a protective garment for use by persons who work in chemically hazardous areas. The garment receives temperature-regulated air from an external air source, and comprises an outer torso covering layer, a diffuser layer attached to the interior of the outer layer and a belt means for attachment of a vortex tube to an orifice in the garment's outer layer.

U.S. Pat. No. 5,197,294 to Galvan et al. describes a portable apparatus for air conditioning comprising an assembly made up of a Peltier effect thermoelectric device, in the form of bimetallic or plurimetallic plates connected to a low voltage D.C. power supply. The opposed cold and hot surface of the thermoelectric device are in contact with respective heat exchangers. The assembly is contained in a housing in which two distinct and separate conduits are provided for the forced flow of air through the respective ones of said heat exchangers.

U.S. Pat. No. 5,320,164 to Szczesuil et al. describes a body heating/cooling garment which utilizes fluid-carrying tubes and provides both air and vapor permeability to promote convective heat transfer while also providing conductive heat transfer. The garment comprises a vapor/gas porous substrate having an associated air permeability and vapor permeability; a length of tubing adapted to carry heating or cooling fluid therein; and, means for adhesively attaching the tubing to the substrate.

U.S. Pat. No. 6,105,382 to Reason describes a cooling and heating device that may be used in conjunction with a personal air conditioned apparatus. The cooling/heating device is associated with a protective suit completely covering the user and also provides ballistic protection for the person using the personal conditioned air apparatus.

U.S. Pat. No. 6,584,798 to Schegerin describes a cooling system for human body that comprises garment worn near a body of a subject. The cooling system includes several fine pipes forming a garment circuit in which a fluid circulates through a heat exchanger with solid carbon dioxide.

Most of the heating/cooling systems described above, however, remain heavy and uncomfortable to the user. Their applications are mainly limited to various protective body suits which restrict the movement of the user. Likewise, heavy man-mounted cooling systems can increase metabolic load because of the added weight that exacerbates problems of muscular fatigue and heat strain.

U.S. Pat. No. 6,823,678 to Li describes a wearable air conditioner system that provides cooling or heating to a flexible material-based device incorporated into standard apparel such as shirts, pants, jackets, dresses, etc. The air system includes a ventilation portion located within a flexible material body, a thermoelectric module with heat exchangers on opposite sides, an air stream source, and a power source. The ventilation portion has two chambers formed between a flexible material inner layer, an air delivery layer and a flexible material outer layer with a plurality of air vents in each of the flexible material inner and outer layers. Each of the heat exchangers is in fluid communication with one of the chambers. The air stream source provides an air flow through the heat exchangers into the chambers and out through the plurality of vent holes.

A disadvantage of the wearable air conditioner system described in U.S. Pat. No. 6,823,678 is in the fact that the ventilation portion located within a flexible material body includes a number of built-in thermoelectric modules which are distributed along the user's body and are powered by relatively high voltage. Wearing such electricity on the body decreases the safety of the user. Moreover, employing a large number of thermoelectric modules increases the weight and cost of the suit. Likewise, this may provide certain difficulties in laundering such a body suit.

U.S. Pat. No. 6,510,696 to Guttman et al., and assigned to the Applicant of the present Application, discloses a thermoelectric air conditioning apparatus comprising a housing having a plurality of air inlets and a plurality of air outlets, a plurality of thermoelectric elements, two heat exchangers, a temperature regulator, two air circulation units and a control unit. The temperature regulator has first and second air inlets, a main air outlet and at least one exhaust outlet. The thermoelectric elements are energized, and cause a reduction of temperature on one side and an increase of temperature on the other side. One air flow produced by a blower of a first circulation unit is forced to flow through one of the housing air inlets, over a heat exchanger and to the first air outlet of the temperature regulator. Another air flow produced by a blower of a first circulation unit is forced to flow through one of the housing inlets, over the other heat exchanger and to the second air outlet of the temperature regulator. The temperature of the air leaving the main outlet of the temperature regulator is determined by proportioning the flow of air from the first air inlet of the temperature regulator and the air flow from the second air inlet of the temperature regulator into and through the main outlet of the temperature regulator.

The thermoelectric air conditioning apparatus described by Guttman et al. is configured to communicate with a body suit. The body suit comprises one or more air conditioning hose attachments, an inner layer, and an outer layer. A plurality of flexible spacers is employed to separate the inner layer from the outer layer and allow air to flow through a space confined by the spacers and the layers. The inner layer has a large number of holes, arranged in a plurality of arrays, each array configured to allow air to flow over a certain portion of the body of the suit wearer.

A personal air-conditioning system can also be used to stabilize an individual's body temperature while operating non-climate controlled motorized vehicles, such as all terrain vehicles, snowmobiles and small aircrafts with an open or closed occupant compartment.

A personal air-conditioning system can be especially useful for electric vehicles and hybrid electric vehicles which are recently becoming increasingly popular for certain consumer segments. Likewise, fuel cell automobiles using a fuel cell engine are also growing in popularity as attractive alternatives to automobiles using standard gasoline powered engines.

One of the main problems associated with this type of vehicles is the fact that electric power source technology (based on batteries or fuel cells) is not robust, which limits the application range of these vehicles. Moreover, a powerful power consumer, such as a conventional cabin heating, ventilation and air-conditioning (HVAC) microclimate system, requires a great deal of energy that puts a significant burden on the power source. Thus, it is not practical for electrical and fuel cell engine vehicles to use conventional electric HAVC microclimate systems, since the extra energy that is required to power such systems can reduce the fuel mileage of the vehicle and lead to higher operating costs and the inconvenience of more frequent stops for refueling. Energy diverted to the HVAC microclimate systems also increases operating costs, and reduces the lifetime of the vehicle batteries by subjecting them to more discharge cycles.

### GENERAL DESCRIPTION OF THE INVENTION

Despite the prior art in the area of personal heating/cooling systems, there is still a need in the art for further improvement in order to provide a air-conditioning system that is personally adaptable and responsive to a user's changing needs, portable, controllable, lightweight, and easily incorporated into a thin, flexible garment for providing ventilation, heating or cooling to physiologically relevant parts of the body of the user, all the features combined in a single package.

It would be advantageous to provide a personal air-conditioning system in conjunction with an apparel that minimizes restrictions of user movement, while closely conforming to body thermoregulation mechanisms of the user, to provide optimum heat transfer between the apparel and the user.

It would also be advantageous to provide a portable air-conditioning system in the form of a garment that allows escape of perspiration from the body of the user.

For air cooling systems, heat exchange is a function of air stream velocity, density, and temperature. Cooling, drying or increasing volumetric flow rates (air delivery rates) of the ingress air stream enhances heat removal. Thus, it would also be advantageous to provide a personal air-conditioning system configured to controllably operate in a heating or cooling regime depending on the weather conditions and/or individual requirements of the user.

It would further be advantageous to provide such an automotive HVAC microclimate system which can minimize energy consumption during operation of an automobile. Therefore, a personal air-conditioning system that can provide personal heating and cooling to the occupants of vehicles can offer a more efficient system for electric vehicles and/or vehicles with a limited electrical system rather than systems which provide full cabin volume cooling and heating.

Moreover, utilizing a personal air-conditioning system allows minimizing the amount of time and money required by automakers to re-design existing vehicles for installation of such a system. The ability to minimize design changes in vehicles can provide manufacturers with manufacturing flexibility, increased production capacity and shorten the time to market the product.

The present invention partially eliminates disadvantages of the prior art techniques and provides a novel personal air-conditioning system comprising an air moving device operable to provide an air stream characterized by at least one predetermined air stream parameter. The system also includes a flexible ventilation section being in air flow communication with the air moving device and configured to provide an air stream to a user of the personal air-conditioning system. The system also includes a control unit coupled to the air moving device for controlling operation thereof by regulating the at least one predetermined air stream parameter.

According to one embodiment of the invention, the control can be an open loop control that can be carried out by the user of the garment or by a remote operator. According to another embodiment of the invention, the control can be a closed loop control carried out automatically on the basis of the measurements of physiological characteristics of the user and/or ambient parameters of the environment, as will be described hereinbelow.

The air moving device is operable to provide an air stream characterized by at least one predetermined parameter, e.g., a predetermined temperature, humidity and air delivery rate.

According to one embodiment of the invention, the air moving device is an air conditioner device configured to provide a warm air stream(s) or a cool air stream(s) to a flexible ventilation section(s) on a portion(s) of a single garment or on section(s) of multiple garments, worn simultaneously by the user (i.e. a wearer of a garment). The term ‘portion’ as used herein refers to any desired area(s) on the garment, chosen by the wearer/user for the purpose of providing such ventilation, and may refer to any item(s) of apparel.

An example of such an air conditioner device includes, but is not limited to, a thermoelectric air conditioner device. According to another embodiment of the invention, the air moving device is selected from a mini-fan, blower and impeller, each device being operable to bring air from the outside environment into the flexible ventilation section of the garment (i.e., item of apparel) without preliminary cooling or heating.

The control unit includes, inter alia, sensing devices and a computer unit coupled to the sensing devices.

The sensing devices are configured for measuring at least one physiological characteristic of a user of the personal air-conditioning system, and producing at least one sensor signal indicative of the physiological characteristic. Examples of such physiological characteristics include, but are not limited to, temperature of the skin, perspiration, blood pressure and pulse of the user. When required, the sensing devices can also be configured for measuring ambient parameters, e.g., ambient temperature, ambient humidity, ambient wind speed, ambient sun radiation, etc.

According to an embodiment of the invention, the sensing devices are coupled to the control unit. Examples of the sensing devices include, but are not limited to one or more electric thermometers, one or more humidity sensors, a blood pressure sensor, a pulse sensor, etc.

The electric thermometers are configured for measuring the temperature of the skin and/or ambient temperature, and producing a skin temperature sensor signal and/or an ambient temperature sensor signal. The humidity sensors are configured for sensing perspiration of the user and/or ambient humidity, and producing a skin humidity sensor signal and/or an ambient humidity sensor signal. The blood pressure sensor is configured for measuring the blood pressure of the user and producing a blood pressure sensor signal. The pulse sensor is configured for measuring the pulse of the user and producing a pulse sensor signal.

Furthermore, the sensing devices can be configured to measure such parameters, such as a battery charge, a presence of the user in the vicinity of the personal air-conditioning system, etc. For example, the sensing devices can include at least one sensor device selected from a battery charge sensor and a proximity sensor. In particular, the proximity sensor can be configured to register the presence of the user in the vicinity of the personal air-conditioning system and generate a presence control signal.

The computer unit is configured for analyzing the sensor signals and generating at least one control signal required for controlling the personal air-conditioning system. For example, the controlling of operation of the system can be achieved by regulating the predetermined temperature, humidity and/or air delivery rate of the air stream.

According to an embodiment of the invention, the personal air-conditioning system further comprises a heater arranged downstream of the air conditioner device. The heater is responsive to a corresponding heat control signal provided by the control unit for controllable heating the air stream.

The personal air-conditioning system is portable and configured to receive electric power from various electric power sources. For example, the personal air-conditioning system can receive electric power from an autonomous electric power source arranged within the item of apparel in a certain place in the vicinity of the user's torso. In this case, the autonomous electric power source can act also as a shield for ballistic protection of the user.

According to a further embodiment of the invention, the personal air-conditioning system further comprises a sanitary module arranged upstream of the flexible ventilation section. The sanitary module can include a capsule containing a predetermined pharmaceutical composition or fragrance, and is configured for controllably dispensing this predetermined pharmaceutical composition or fragrance into the air stream to benefit a user (i.e. wearer) of the item of apparel.

According to an embodiment of the present invention, the flexible ventilation section is in the form of a multi-layered structure including an outer layer made of a dense material to prevent penetration of the air stream therethrough, and an air delivery layer containing a plurality of vent openings. The vent openings are distributed within at least a portion of the air delivery layer so as to provide the air stream optimally to physiologically sensitive areas of a body of the user through the plurality of the vent openings. The outer layer and the air delivery layer are bound to each other along their borders to define a ventilation chamber therebetween. The ventilation chamber is in air flow communication with the air moving device.

The multi-layered structure of the flexible ventilation section can further include a spacer layer (also referred to as a first spacer layer) adjacent to the inner surface of the air delivery layer. The spacer layer is designed to provide homogeneous distribution of the air stream and prevent collapse of the space between the garment and the skin of the user.

The multi-layered structure of the flexible ventilation section can further include another (second) spacer layer sandwiched between the outer layer and the air delivery layer. Such a second spacer layer is designed to provide homogeneous distribution of the air stream within the ventilation chamber and avoid collapse of the space of the ventilation chamber.

According to an embodiment, the multi-layered structure of the flexible ventilation section can yet include a ballistic resistant layer adjacent to the external surface of the outer layer to protect a body of the user from ballistic forces.

The multi-layered structure of the flexible ventilation section can further include an inner layer adjacent to said first spacer layer from the inner surface thereof. The inner layer is designed to breathe by providing extraction and conveyance of perspiration, both vapor and/or liquid, from the user's skin therethrough.

According to another embodiment of the invention, the multi-layered structure comprises an inner layer, an outer layer, an air delivery layer located between the inner layer and the outer layer, and containing a plurality of vent openings. The inner layer, the outer layer and the air delivery layer are bound to each other along their borders to define a first ventilation chamber between the inner layer and the air delivery layer, and a second ventilation chamber between the outer layer and the air delivery layer. According to this embodiment of the invention, the first ventilation chamber is in air flow communication with said air moving device. The air flow provided to the first ventilation chamber is forced to pass through the plurality of vent openings into the second ventilation chamber. The structure of the flexible ventilation section can further include a first spacer layer sandwiched between the inner layer and the air delivery layer so as to permit air ventilation and avoid collapse of the space of the first ventilation chamber. The structure of the flexible ventilation section can further include a second spacer layer sandwiched between the air delivery layer and the outer layer so as to permit air ventilation and avoid collapse of the space of the second ventilation chamber.

According to this embodiment of the invention, the inner layer is formed from a breathing porous material to permit ventilation of air and conveyance of perspiration exuded by a user of said garment therethrough. The inner layer can have hydrophobic characteristics.

The outer layer of the structure of the flexible ventilation section can have thermal insulating characteristics to protect a user of said garment from external weather conditions. For example, the outer layer can be made of a material comprising a phase change material. When required, the outer layer can be covered with a reflective coating formed on the external surface thereof and adapted to reflect ambient electromagnetic radiation impinging thereon. When required, the air delivery layer can have hydrophilic characteristics for absorbing perspiration exuded by a user of said garment.

According to the invention, the personal air-conditioning system comprises a hose adapter. Depending on the requirements, the hose adapter can provide connection of the air moving device either to the first ventilation chamber or to the second ventilation chamber, thereby to provide air communication between the air moving device and the flexible ventilation section.

For example, when the ventilation chamber is integrated with a portion of a garment (item of apparel) having a frontal part and a rear part, the hose adapter can be in the form of a fork manifold having an inlet and two outlets. The two outlets can be coupled to either the first ventilation chamber or the second ventilation chamber at the frontal part and the rear part of the item of apparel, respectively. Preferably, the system further comprises a universal connector configured for connecting the inlet of the hose connector to various kinds of air moving devices.

According to an embodiment of the invention, the system further comprises an air deflector arranged within the hose adapter and adapted for changing proportion of the air distributed between the frontal and rear parts of the item of apparel. According to still another embodiment of the invention, the flexible ventilation section further can include a ballistic resistant layer adjacent to an external surface of the outer layer to protect the body of a user/wearer of said item of apparel from ballistic forces.

According to another aspect of the invention, there is provided a method of operating the personal air-conditioning system. The method includes measuring the sensing parameters. The sensing parameters can for example, be selected from physiological characteristics of the user of the item of apparel and ambient parameters. When the personal air-conditioning system is integrated with an electrical vehicle or a vehicle with limited electrical system (i.e., with limited battery capacity and with a charging system having limited power), the method can include measuring of vehicle parameters, such as a vehicle battery charge state, a vehicle main switch state, a presence of the user in the vicinity of the air-conditioning system, etc. The method also includes the step of generating the sensor signals indicative of the sensing parameters. Further, the method includes the step of analyzing the sensor signals and generating control signals required for the controlling of the operation of the air moving device.

According to an embodiment of the invention, the controlling of the operation of the air moving device includes regulating any of the predetermined parameters of the air moving device in a predetermined manner during the time of operation. For example, it can include cyclically activating an idle regime of the operating of the air moving device.

Moreover, the operating of the air moving device can be carried out in a sequence of three cyclic regimes. For example, a first cyclic regime can be characterized by a high value of the air delivery rate, a second cyclic regime is characterized by a value of the air delivery rate, and a third cyclic regime is the idle regime.

According to an embodiment, the method can include activating a sanitary capsule module during at least one cyclic regime for controllably dispensing a predetermined pharmaceutical composition or fragrance into the air stream to benefit a user of the item of apparel.

The personal air-conditioning system of the present invention has many of the advantages of the prior art techniques primarily by better complying to the natural thermoregulation mechanisms of the human body, while simultaneously overcoming some of the disadvantages normally associated therewith.

The personal air-conditioning system according to the present invention may be easily and efficiently manufactured.

The personal air-conditioning system is of durable and reliable construction.

The personal air-conditioning system according to the present invention may have a low manufacturing cost.

There has thus been outlined, rather broadly, the more important features of the invention so that the detailed description thereof that follows hereinafter may be better understood, and the present contribution to the art may be better appreciated. Additional details and advantages of the invention will be set forth in the detailed description.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates a general schematic view a personal air-conditioning system, according to one embodiment of the present invention;

FIG. 2A through FIG. 2E illustrate a cross-section of the flexible ventilation section of the personal air-conditioning system along plane A-A′ of FIG. 1, according to several various embodiments of the present invention;

FIG. 3A and 3B illustrate general schematic views of a personal air-conditioning cooling system, according to other embodiments of the present invention;

FIGS. 4A and 4B illustrate schematic diagrams of air delivery rate and temperature waveforms used for operating a thermoelectric conditioner device in an effective cooling and heating regime, respectively, according to one embodiment of the invention;

FIG. 5 is a schematic illustration of a personal air-conditioning system of the invention employing an open loop control, according to an embodiment of the invention;

FIG. 6 is a schematic illustration of distribution of vent openings in the air delivery layer, according to an embodiment of the invention, and

FIG. 7 illustrates a general schematic view a personal air-conditioning system configured for occupants of a vehicle, according to an embodiment of the present invention.

### DETAILED DESCRIPTION OF THE INVENTION

The principles and operation of a personal air-conditioning system according to the present invention may be better understood with reference to the drawings and the accompanying description; it being understood that these drawings are given for illustrative purposes only and are not meant to be limiting.

The same reference Roman numerals and alphabetic characters will be utilized for identifying those components which are common in the personal air-conditioning system and its components shown in the drawings throughout the present description of the invention. It should be noted that the blocks in the drawings illustrating various embodiments of the present invention are intended as functional entities only, such that the functional relationships between the entities are shown, rather than any physical connections and/or physical relationships. It should be noted that these drawings are not to scale, and are not in proportion, for purposes of clarity.

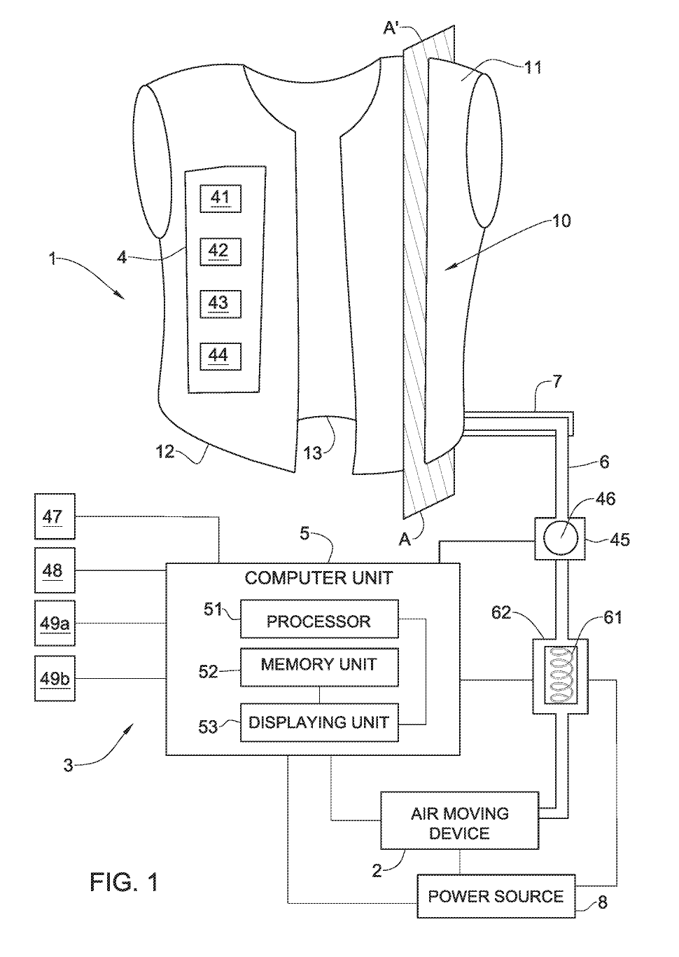

Referring now to FIG. 1 a schematic view a personal air-conditioning system 1 is illustrated, according to one embodiment of the present invention. The personal air-conditioning 1 includes a flexible ventilation section 10 associated with at least a portion of an item of apparel 11 in the form of a vest, an air moving device 2 being in air communication with the flexible ventilation section 10, and a control unit (system) 3 coupled to the air moving device 2.

According to the embodiment shown in FIG. 1, the air moving device 2 is coupled to the flexible ventilation section 10 via a hose 6. A hose adapter 7 can be arranged for providing the connection between the flexible ventilation section 10 and the hose 6.

According to another embodiment (not shown), the air moving device 2 can be directly connected to the flexible ventilation section 10 via the hose adapter 7.

The air moving device 2 is operable to provide an air stream (not shown) having a predetermined temperature. Preferably, the flexible ventilation section 10 extends from a frontal part 12 of the item of apparel 11 to a rear part 13 of the item of apparel 11, thereby to provide heating or cooling to a large area of the body of a user (not shown).

It should be understood that this type of garment is shown by way of illustration only, and that the flexible ventilation section 10 may be incorporated into any existing type of garment or item(s) of apparel, including, but not limited to coats, jackets, dresses, skirts, shorts, trousers, footwear, headwear, collar, gloves, or any combination thereof.

It is apparent that when required, the flexible ventilation section can also be incorporated into any other flexible material-based device, e.g., a sleeping bag, bed-clothes, blanket or seat equipped with air delivery apparatus, etc.

The personal air-conditioning system 1 can find great utility in use with open occupant compartment motorized vehicles such as motorcycles, terrain vehicles, golf carts, tractors, forklifts, etc. Moreover, the personal air-conditioning system 1 can find utility in electrical vehicles or vehicles having limited electrical power and limited charging system in order to provide personal heating and cooling to the occupants of vehicles rather than to provide full cabin volume cooling and heating, and thereby to minimize energy consumption during operation of the vehicle. As will be described herein below in detail, for these types of vehicles, the flexible ventilation section of the personal air-conditioning system 1 can, for example be in the form of a car seat cover, or incorporated in a vehicle seat.

It should also be understood that, when required, the flexible ventilation section can be incorporated in a sealed mask, e.g., NBC (nuclear biological and chemical) mask, providing the possibility for a user to inhale a cool/warm air stream.

The air flow stream provided by the air moving device 2 can be either a warm air flow stream or a cool air flow stream. According to one embodiment of the invention, the air moving device 2 is a suitable air conditioner device configured to provide warm and/or a cool air flow streams. For instance, the suitable air conditioner device can be a portable thermoelectric air conditioner device designed for carrying by the user. Likewise, the suitable air conditioner device can be an air conditioner device configured for a vehicle. An example of a suitable air conditioner device includes, but is not limited to, the thermoelectric air conditioner device described by the Applicant of the present Application in U.S. Pat. No. 6,510,696, the disclosure of which is incorporated hereby by reference into this description.

According to an embodiment of the invention, the control unit 3 includes various sensing devices (means) 4 incorporated into the garment 11 and configured for sensing certain physiological characteristics of the user and ambient parameters, and a computer unit 5 coupled to the sensing devices 4. The computer unit 5 has, inter alia, such known utilities as a processor 51 (data acquisition and processing utility), a memory unit 52, and a displaying unit 53 configured for presenting sensed and controlled results. The processor 51 is preprogrammed by a suitable software and/or hardware model capable of analyzing the received output of the sensing devices 4 and providing one or more control signals for controlling the operation of the personal air-conditioning system 1. The displaying unit 53 can include a mini-display and/or other monitoring devices (not shown).

It should be understood, although not specifically shown, that the computer unit 5 of the control unit 3 can be incorporated into the garment 11. Alternatively, the computer unit 5 and the air moving device 2 can be mounted in a common housing (not shown) apart from the garment 11. The computer unit 5 can be coupled to the air moving device 2 and the sensing devices 4 wirelessly or by means of electric wires.

According to an embodiment of the invention, the control can be a closed loop control carried out automatically on the basis of the measurements of physiological characteristics of the user and/or ambient parameters of the environment. According to one embodiment of the invention, the suitable software and/or hardware model is based on predetermined algorithms of operating the air moving device 2. The predetermined algorithms are based on a physiological model of human thermoregulation mechanisms. The physiological model can rely on objective data corresponding to physiological characteristics measured by the sensing devices as well as on the subjective feeling of well-being of the user. Examples of predetermined algorithms of operating the air moving device 2 will be described hereinbelow.

According to another embodiment of the invention, the suitable software and/or hardware model is based on learning algorithms. Such algorithms are known per se in neural networks and other artificial intelligence systems and may involve tracking the manner of operating the air moving device 2 by the user in a manual control regime as a function of his various physiological characteristics measured by the sensing means, analyzing the user's behavior and operating the air moving device 2 in an automatic control regime based on the learned behavior.

For example, the sensing devices 4 can include an electric thermometer 41 incorporated into the garment and arranged to be in contact with the skin of the user. The electric thermometer 41 is configured for measuring the temperature of the skin and producing a temperature sensor signal representative of the skin temperature. The processor 51 can be responsive to the skin temperature sensor signal, and generate a skin temperature control signal for controlling at least one predetermined parameter of the air moving device, such as temperature of the air stream, humidity of the air stream and/or air delivery throughput of the air moving device 2 (i.e. volume of the air provided by an air moving device per time unit). For example, if the temperature of the skin is higher than the normal temperature, the processor 51 can produce the skin temperature control signal to the air moving device for activating thereof to provide a cool air stream of a predetermined temperature and air delivery rate.

According to an embodiment, the sensing devices 4 can also include a skin humidity sensor 42 configured for sensing perspiration of the user. The skin humidity sensor 42 can, for example, employ the fact that electric conductivity of skin depends on perspiration, due to the electrical conductivity of sweat. Therefore, the skin humidity sensor 42 can, for example, be a device based on measurements of electrical conductivity or impedance of the skin. In this case, the skin humidity sensor 42 can be configured for producing a humidity sensor signal representative of the skin conductivity. The processor 51 can be responsive to the humidity sensor signal for controlling humidity of the skin by varying at least one aforementioned predetermined parameter, such as temperature of the air stream, humidity of the air stream and air delivery throughput of the air moving device 2.

For instance, if the skin is wet, it can be dried by a dry air stream passing through the flexible ventilation portion 10 of the garment. The dry air stream can be controllably provided by a dehumidization process in two stages. At the first stage, the external air brought from the outside environment can be cooled by an air conditioner device to provide a cool air flow stream. During the cooling, a part of the water molecules dispersed in the external air will be condensed on heat exchangers (heat sink) of the air conditioner device. As a result of the water condensation, although the relative humidity of the cool air stream may remain unchanged, the absolute humidity of this air is decreased. Thus, at the second stage, heating the cool air stream can provide a warm air stream having a decreased relative humidity. This relatively dry air stream can be utilized for controllable drying of the wet skin of the user.

In order to heat the cool air stream, the air-conditioning system 1 can further include a heater 62 arranged downstream of the thermoelectric air moving device 2. The heater 62 can be any known air heating device responsive to a corresponding heat control signal provided by the processor 51 for the controllable heating of the cool air stream. The heater 62, for example, can include a coil 61 arranged at an air passage of the cool air stream, and coupled to a source of electrical current 63. The control unit 3 can be configured to regulate the current passing across the coil 61, thereby to provide controllable heating of the cool air stream. It should be noted that the heater 6 can, for example, be a dedicated device. Alternatively, the heater 6 can be incorporated in the air moving device 2. For example, when the air conditioner device described in U.S. Pat. No. 6,510,696 is utilized for providing the air stream, the air moving device 2 and the heater 6 are both mounted in a common housing (not shown).

According to still another example, the sensing devices 4 can also include a blood pressure sensor 43 configured for measuring the blood pressure of the user and producing a blood pressure sensor signal representative of the blood pressure. The processor 51 can be responsive to the blood pressure sensor signal for controlling the blood pressure by varying the temperature of the air stream and air delivery rate. Thus, in order to elevate the blood pressure, the user can be heated by providing a warm air stream, and, vice versa, cooling the user can decrease his blood pressure. For example, when the blood pressure exceeds the value of about 130/90 mm Hg, the user has to be cooled, and vice versa, when the blood pressure is less than about 90/60 mm Hg, the user has to be heated.

According to yet another example, the sensing devices 4 can also include a pulse sensor 44 configured for measuring the pulse rate of the user and producing a pulse sensor signal representative of the magnitude of the pulse rate. The processor 51 is responsive to the pulse sensor signal for regulating the pulse rate by varying the temperature of the air flow stream and air delivery throughput of the air moving device 2. Thus, in order to increase the user's pulse rate, the user can be heated by providing a warm air stream, and, vice versa, cooling the user can decrease his pulse rate. For example, when the pulse rate exceeds the value of about 90 beats per minute, the user has to be cooled, and vice versa, when the pulse rate is less than 60 beats per minute, the user has to be heated.

It should be understood that the sensing capabilities of the control unit 3 may not be limited by utilization of the sensing devices 41-44. When required, the sensing devices 4 can include also other sensing devices. For example, the sensing devices 4 can include an electrocardiogram (ECG) sensor for determining activity of the heart of the user and producing an ECG sensor signal, electroencephalogram (EEG) sensor for determining activity of the brain of the user and producing an EEG sensor signal, etc.

According to an embodiment of the invention, the sensing means are further configured for measuring ambient parameters. Examples of the ambient parameters include, but are not limited to ambient temperature, ambient humidity, ambient wind speed, ambient sun radiation, etc.

Accordingly, the sensing devices 4 can include an external electric thermometer 47 exposed to the environment. The external electric thermometer 47 is configured for measuring the ambient temperature and producing an ambient temperature sensor signal representative of the ambient temperature. The processor 51 can be responsive to the ambient temperature sensor signal, and generate ambient temperature control signal for controlling at least one predetermined parameter, e.g., temperature of the air stream, humidity of the air stream and air delivery throughput of the air moving device 2.

Likewise, when required, the sensing devices 4 can also include an ambient humidity sensor 48 exposed to the environment and configured for sensing ambient humidity and producing an ambient humidity sensor signal. The processor 51 can be responsive to the ambient humidity sensor signal for varying temperature of the air stream, humidity of the air stream and air delivery throughput of the air moving device 2, as required in accordance with the physiological model of the human thermoregulation mechanisms.

Moreover, when required, the sensing devices 4 can also include the corresponding wind flow meter 49a and sun radiation sensor 49b exposed to the environment and configured for sensing ambient wind speed and sun radiation, and producing a wind flow sensor signal and a sun radiation sensor signal, respectively. The processor 51 can be responsive to the wind flow sensor signal and the sun radiation sensor signal for varying at least one predetermined parameter, such as a temperature of the air stream, humidity of the air stream and an air delivery throughput of the air moving device 2, as required in accordance with the physiological model of the human thermoregulation mechanisms.

According to another embodiment of the invention, the control of operation of the air-conditioning system can be an open loop control that can be carried out by the user of the personal air-conditioning system. Thus, depending on the data of his physiological characteristics or on his/her subjective feeling of well-being, the user can activate directly, or via a predetermined algorithm, the operation of the air moving device 2, thereby to provide air stream having preprogrammed temperature, humidity and air delivery rate.

As described above, the system can also utilize a learning algorithm employing a regime of operating the air moving device 2 based on a learned reaction of the user to certain physiological characteristics and/or the user's subjective feeling of well-being.

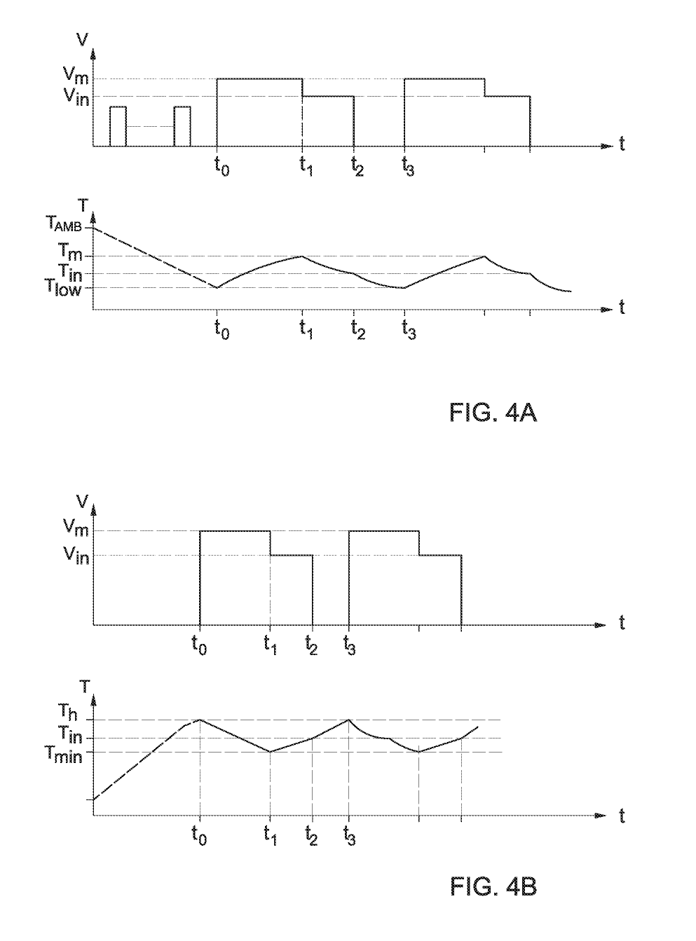

According to an embodiment of the invention, the air-conditioning system of the invention can be controlled by a remote operator. Referring to FIG. 5, a schematic illustration of a air-conditioning system 70 employing an open loop control carried out by a remote operator 71 is illustrated, according to an embodiment of the invention. In this case, the remote operator 71 can conduct the open loop control wirelessly, e.g., by means of radio frequency transmission.

According to this embodiment of the invention, the control unit 3 can further include transmitting and receiving units arranged at the end of the remote operator 71, and transmitting and receiving units at the end of the user, respectively, for providing communication between the air moving device 2, sensing devices 4 and the remote operator 71 of the control unit 3.

More specifically, the control unit 3 can include a user transmitter 72 arranged at the end of the user of the garment 11. The user transmitter 72 is configured for transmitting the sensor signals generated by the sensing devices 4 to the remote operator 71. The control unit 3 can further include an operator receiver 73 arranged at the end of the remote operator 71. The operator receiver 73 is configured to receive the sensor signals and provide the sensing parameters represented thereby to the remote operator 71. The control unit 3 can also include an operator transmitter 74 arranged at the end of the remote operator 71. The operator transmitter 74 is configured for transmitting a remote operator control signal provided by the remote operator 71. The control unit 3 can also include a user receiver 75 arranged at the end of the user of the garment 11, the user receiver is configured for receiving the remote operator control signal and relaying this signal to the computer unit 5 of the control unit 3. According to this embodiment, the computer unit 5 is coupled to the user receiver 75, and configured for analyzing the remote operator control signal for generating the control signals, thereby to operate said control unit in an open loop control mode.

The remote open loop control of the air-conditioning system 71 can, for example, be utilized for providing comfortable microclimate conditions to an army serviceman In combat conditions the values of the physiological characteristics measured by the sensing devices 4 incorporated into the garment 11 can provide indication of the user's physical and emotional states caused by illness, a wound, exercise, fear, nervousness, stress, anxiety, etc. Thus, monitoring by the remote operator of the sensed data indicative of the physiological characteristics and controllably providing comfortable microclimate conditions and regulating the operation of the air moving device 2 can facilitate ability of the military person to perform the required tasks.

According to another embodiment, the air-conditioning system of the present invention can be utilized for providing comfortable microclimate conditions to a patient and/or a disabled person being under medical care. In such a case, a remote carer (e.g., a nurse) can monitor the physiological characteristics of a subject under control and provide remote regulation of the operation of the air moving device 2.

Turning back to FIG. 1, in accordance with a further embodiment of the invention, the personal air-conditioning system 1 of the invention can further include a sanitary module 45 arranged upstream of the flexible ventilation section 10 of the item of apparel 11, to protect the user from results of fungal and/or bacterial growth owing to the sweat remaining on the garment. This fungal and/or bacterial growth can degrade the properties of the garment, can provide noxious odors, and even result in health problems for the user. The sanitary module 45 can include a capsule 46 containing a predetermined pharmaceutical or fragrance composition for sanitizing, deodorizing and/or refreshing the user via the garment 11.

Accordingly, the operation of the sanitary module 45 can be controlled by the user of the garment, by a remote operator (by means of an open loop control) and/or automatically by a closed loop control. Thus, for example, in the latter case, the control unit 3 can be coupled to the sanitary module 45 and configured to generate a sanitary control signal when, for example, the humidity sensor 42 indicates that the user has perspired. The sanitary module 45 can be responsive to the sanitary control signal for controllable dispense of the predetermined pharmaceutical composition into the ingress air stream in order to benefit a user who is sweating. Examples of such a predetermined pharmaceutical composition include, but are not limited to, anti-fungal compositions, anti-bacterial compositions, odor control compositions, etc.

The personal air-conditioning system 1 can receive electric power from an electrical power source 8. Various kinds of electrical power sources 8 can be used. According to an embodiment of the invention, the personal air-conditioning system 1 can be designed as portable, to enable the user to carry it by himself. For example, all the system components shown in FIG. 1 can be mounted on the user's body. In this case, the personal air-conditioning system will receive electric power from autonomous rechargeable batteries. For example, several batteries can be placed in specially designed pockets arranged within the garment 11. In this case, the batteries can be mounted in a certain place of the garment, e.g. in the vicinity of the user's torso, and can act also as ballistic protection for the user. Alternatively, the system can also be powered by a vehicle power source, when the system employs the vehicle's air conditioner device or when a portable air-moving device is mounted on/in said vehicle, or any stationary power outlet.

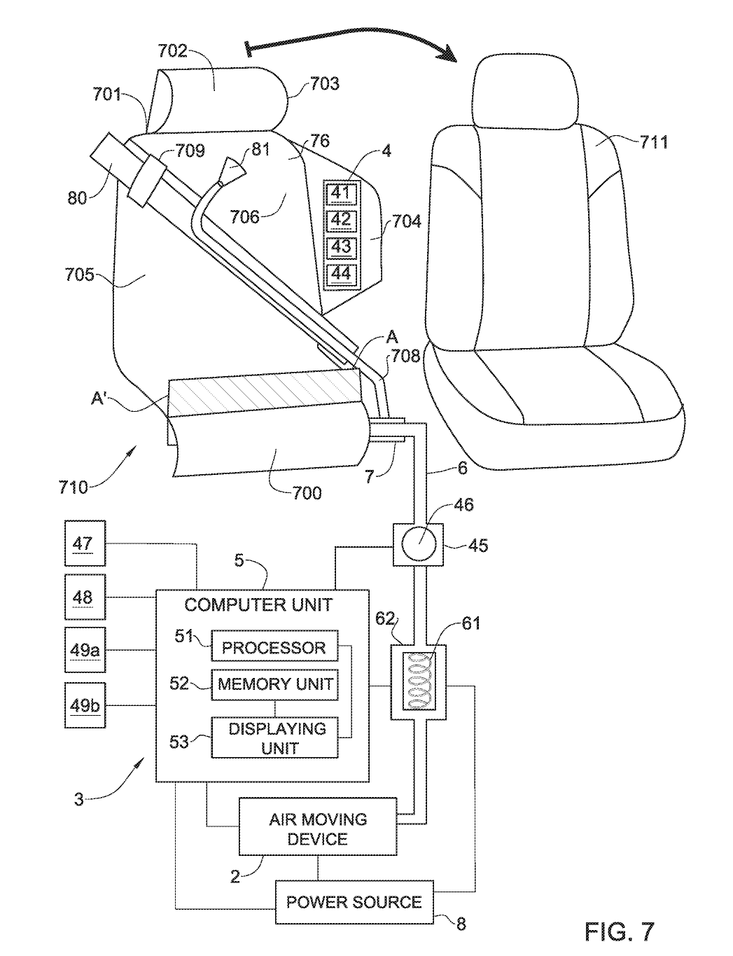

Referring to FIG. 7 a schematic view a personal air-conditioning system 710 is illustrated, according to another embodiment of the present invention. The personal air-conditioning system 710 differs from the personal air-conditioning system (1 in FIG. 1) in the fact that this system is configured for using by occupants in a vehicle. The personal air-conditioning system 710 can be especially useful for electric vehicles, hybrid electric vehicles, fuel cell automobiles using a fuel cell engine, vehicles with limited electrical system and other vehicles, in which a powerful power consumer, such as a conventional cabin heating, ventilation and air conditioning (HVAC) microclimate system is not practical since it requires a lot of energy that puts a significant burden on the power source.

The personal air-conditioning system 710 includes a flexible ventilation section 700 provided in at least a portion of a piece of upholstery 76 attachable to or integrated with a vehicle seat 711, an air moving device 2 being in air communication with the flexible ventilation section 700, and a control unit (system) 3 coupled to the air moving device 2. Examples of the piece of upholstery 76 include, but are not limited to a car seat cover, a vest attached to the seat 711, or a piece of any other garment that can be suitably employed in connection with variety of seats.

According to an embodiment, the air moving device 2 is an economical and compact personal air conditioning device. An example of the air conditioner device includes, but is not limited to, a thermoelectric air conditioner device. The air moving device 2 can be mounted anywhere in the vehicle, for example, as an add-on unit or integrated into the vehicle. The control unit 3 enables selection of the desired heating, ventilating, and air conditioning (HVAC) mode.

The power source 8 is an electrical power source. According to an embodiment, the power source 8 is a vehicle battery power-source connected to the personal air-conditioning system 710. According to another embodiment, the power source 8 is a separate power-source.

According to an embodiment, the flexible ventilation section 700 is mounted on a vehicle seat 711 by means of fasteners. Examples of fasteners include, but are not limited to, elastic bands, hook-and-loop fasteners, hook-and-pile fasteners, or touch fasteners (colloquially known as Velcro).

According to the embodiment shown in FIG. 7, the air moving device 2 is coupled to the flexible ventilation section 700 via a hose 6. A hose adapter 7 can be arranged for providing the connection between the flexible ventilation section 700 and the hose 6. According to another embodiment, the air moving device 2 is directly connected to the flexible ventilation section 700 via the hose adapter 7.

According to an embodiment, the personal air-conditioning system 710 includes a flexible hose 708 coupled to the air moving unit 2, for example through the connector 7. The flexible hose 708 can be bent and be adjusted in order to provide conditioned air to preferred body parts. The flexible hose 708 is equipped with a deflector unit 81 in order to adjust the direction of the airflow stream. When desired, the flexible hose 708 can be connected to the safety belt 80 so that the user may fix the belt to the hose and adjust the direction of the air steam onto the desired body part.

When the personal air-conditioning system is arranged in a vehicle, the sensing devices 4 can include one or more vehicle parameters (not shown), such as a battery charge state, a presence of the user in the vicinity of the air-conditioning system, etc. In operation, the control of the system can be carried out automatically on the basis of the measurements of the vehicle battery charge state, main switch signal (in order to shut down the air-conditioning system when vehicle is switched off), a proximity sensor signal and other signals.

The sensing devices 4 can include a vehicle main switch state sensor that is configured to register the operation vehicle state, whether the engine of the vehicle is operating or switched off.

The sensing devices 4 can include a proximity sensor (not shown) that is configured to register a presence of the user in the vicinity of the personal air-conditioning system and generate a proximity sensor signal. In operation, the personal air-conditioning system can be configured to be switch on or off in response to the proximity sensor signal (e.g., IR signal) obtained from the proximity sensor such that when the user is in proximity of the sensor, the air-conditioning system turns on. On the other hand, when the user is away from the sensor, the air-conditioning system turns off.

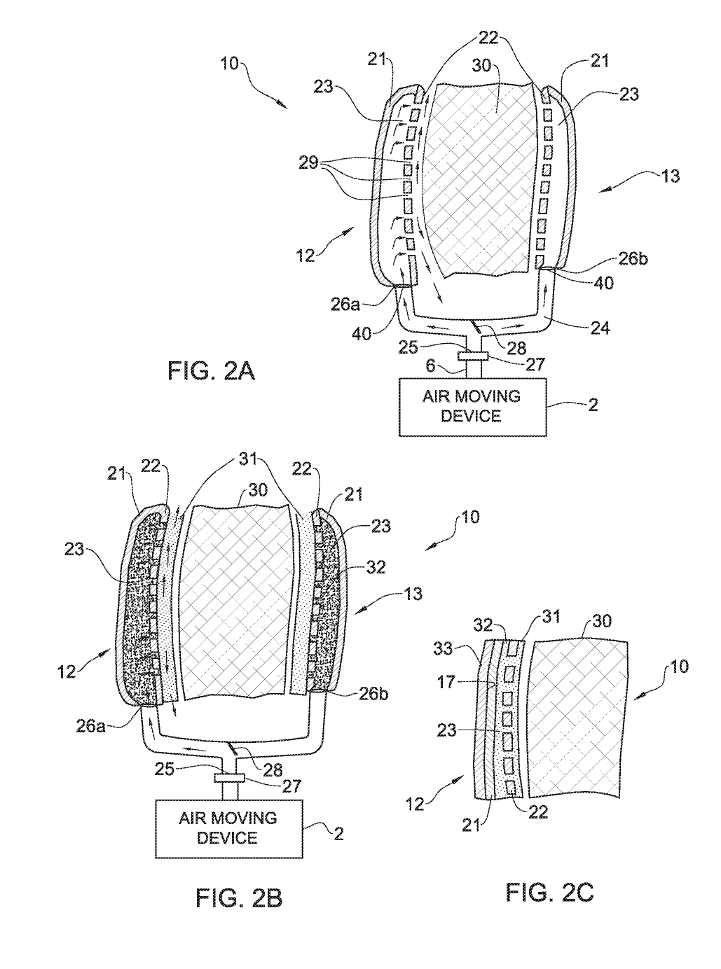

Turning now to FIG. 2A, there is illustrated a cross-section of the flexible ventilation section 10 along plane A-A′ of FIG. 1, according to one embodiment of the present invention. The flexible ventilation section 10 has a multi-layered structure comprising an outer layer 21 and an air delivery layer 22 with respect to a user, a body of which is shown schematically and indicated by a reference numeral 30.

The outer layer 21 and the air delivery layer 22 are bound to each other along their borders to define a ventilation chamber 23 therebetween. The ventilation chamber 23 is coupled to a hose adapter 24 via openings 40 at a bottom of the ventilation chamber 23. The hose adapter 24 is configured for receiving an ingress air stream (shown by arrows) provided by the air moving device 2 coupled thereto. Preferably, but not mandatory, the hose adapter 24 is in the form of a fork manifold having one inlet 25 and two outlets 26a and 26b. The outlets 26a and 26b are coupled to the openings 40 of the ventilation chamber 23 at the frontal part 12 and the rear part 13 of the item of apparel (11 in FIG. 1), respectively. The inlet 25 is preferably arranged with a universal connector 27 enabling the hose adapter 24 to be connected to various kinds of air moving devices. The universal connector 27 can be equipped with a quick connect/disconnect mechanism (not shown) for quick connection/disconnection of the air moving devices. It should be understood that the air moving device 2 can be coupled to the universal connector 27 via the hose 6. Alternatively, the air moving device 2 can be connected directly to the universal connector 27.

Preferably, but not mandatory, the air conditioning hose adapter 24 is equipped with an air deflector 28 adapted to change proportion of the air distributed between the frontal and rear parts 12 and 13.

According to an embodiment of the invention, the outer layer 21 is made of a dense material for preventing penetration of the air stream therethrough. An example of this material includes, but is not limited to, Cordora, and Nylon. The air delivery layer 22 contains a plurality of vent openings 29.

According to one embodiment of the invention, the vent openings 29 are formed as artificially formed apertures in a fabric from which the air delivery layer 22 is made. According to another embodiment, the air delivery layer 22 is made of a foraminated material including a plurality of pores in order to provide air ventilation therethrough. Because the ventilation chamber 23 is sealed, the ingress air stream (shown by arrows) entering the ventilation chamber 23 is forced to pass through the vent openings 29 of the air delivery layer 22 towards the user 30.

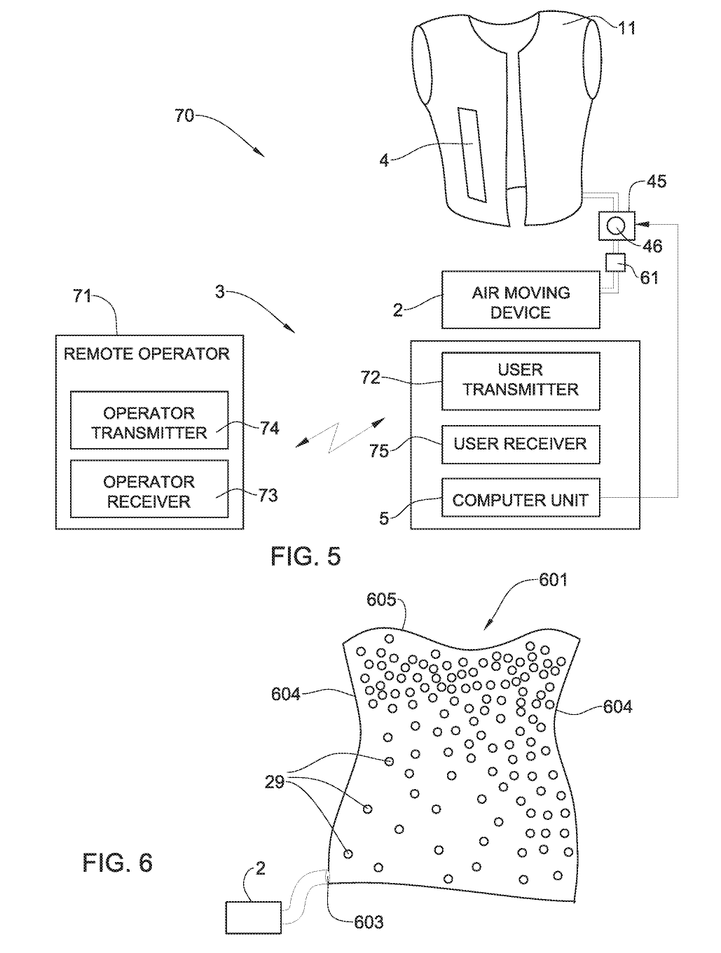

Preferably, but not mandatory, the distribution of the vent openings 29 within at least a portion of the air delivery layer 22 has a predetermined pattern so as to provide an air stream optimally to physiologically sensitive areas of the user's skin. Referring to FIG. 6, an example of a non-uniform pattern 601 of distribution of the vent holes is illustrated. According to this example, the density of the vent openings 29 increases with the distance from the air ingress inlet 603. Moreover, a higher density of vent openings 29 can also be concentrated near physiological important areas, such as the armpits 604 and neck region 605.

As shown in FIG. 2A, the air delivery layer 22 is close to the skin of the user 30 to provide a cool or warm air stream thereto, however other configurations are also contemplated. For example, the air delivery layer 22 can be in direct contact with the skin of the user 30.

When desired, the air delivery layer 22 can also be separated from the skin by an inner layer (not shown) formed from a fabric adjacent to the air deliver layer 22 and/or by an undergarment (not shown).

Referring to FIG. 2B, other embodiments of the invention are illustrated. According to one embodiment, the multi-layered structure of the flexible ventilation section 10 can further include a first spacer layer 31 between the air delivery layer 22 and the skin of the user 30. The first spacer layer 31 is adjacent to the inner surface of the air delivery layer 22 so as to provide homogeneous distribution of the air stream and prevent collapse of the space between the garment and the user's skin.

According to a further embodiment, the multi-layered structure of the flexible ventilation section 10 can further include a second spacer layer 32 sandwiched between the outer layer 21 and the air delivery layer 22, to fill the ventilation chamber 23. The purpose of the second spacer layer 32 is to provide homogeneous distribution of the air stream within the ventilation chamber 23 and avoid collapse of the space of the ventilation chamber 23.

According to one example, the first spacer layer 31 and the second spacer layer 32 are formed from a plastic skeleton in the form of 3D grate. According to another example, the first spacer layer 31 and the second spacer layer 32 are formed from a highly porous percolating material, to permit air ventilation within the ventilation chamber 23 and between the air delivery layer 22 and the user's skin, correspondingly. An example of the materials suitable for the spacer layer 31 includes, but is not limited to 3D nylon mesh.

Referring to FIG. 2C, there is illustrated a cross-section of the frontal part 12 of a flexible ventilation section 10 along plane A-A′ of FIG. 1, according to yet another embodiment of the present invention. According to this embodiment, the multi-layered structure of the flexible ventilation section 10 further includes a ballistic resistant layer 33 adjacent to an external surface 17 of the outer layer 21 to protect a body of the user 30 from ballistic forces. For instance, the ballistic resistant layer 33 can prevent penetration of a projectile bullet and/or knife blade through the garment. The ballistic resistant layer 33 can, for example, be a woven ballistic fabric made of high tensile strength arimid fibers such as Kevlar™ produced by E.I. DuPont de Nemours & Company and/or Twaron™ T-1000 of AKZO NOBEL, Inc. Examples of various lightweight ballistic resistant materials suitable for the ballistic resistant layer 33 are described in U.S. Pat. No. 5,724,670 to Price; U.S. Pat. No. 5,824,940 to Chediak et al; U.S. Pat. No. 6,449,769 to Bachner, Jr. et al; U.S. Pat. No. 6,635,357 to Moxson et. al; and U.S. Pat. No. 6,861,120 to Howland et al, the disclosure of each of these patents is hereby incorporated by reference into this description.

Referring to FIG. 2D, there is illustrated a cross-section of the flexible ventilation section 10 along plane A-A′ of FIG. 1, according to still another embodiment of the present invention. The multi-layered structure of flexible ventilation section 10 further comprises an inner layer 34 adjacent to the first spacer layer 31 from the inner surface 35 thereof.

The inner layer 34 is made of a fabric that can “breathe” and/or act as a wicking layer to provide extraction and conveyance of perspiration both in the vapor and/or liquid from the user's skin through the inner layer 34 or for reducing direct airflow to the body in sensitive areas. For example, the inner layer 34 can be an inner lining associated with the item of apparel (11 in FIG. 1). Examples of the fibers appropriate for preparing the inner layer 34 in accordance with this embodiment of the invention include, but are not limited to, silk and CoolMax™.

Referring now to FIG. 2E, there is illustrated a cross-section of the flexible ventilation section 10 along plane A-A′ of FIG. 1, according to still another embodiment of the present invention.

The configuration of the personal air-conditioning system in accordance with this embodiment distinguishes inter alia from that shown above in FIG. 2D in the fact that for receiving the ingress air stream provided by the air moving device 2 the air conditioning hose connector 24 is coupled to the first spacer layer 31 at its bottom.

According to this embodiment of the invention, the flexible ventilation section 10 has a multi-layered structure comprising an inner layer 101, an outer layer 102, and an air delivery layer 103 located therebetween. The inner layer, the outer layer and the air delivery layer are bound to each other along their borders to define a first ventilation chamber V1 between the inner layer 101 and the air delivery layer 103, and a second ventilation chamber V2 between the outer layer 102 and the air delivery layer 103.

The multi-layered structure of the flexible ventilation section 10 further includes a first spacer layer 104 located in the first ventilation chamber V1 between the delivery layer 103 and the inner layer 101. The multi-layered structure includes also a second spacer layer 105 located in the second ventilation chamber V2 between the air delivery layer 103 and the outer layer 102.

As shown in FIG. 2E, the inner layer 101 is in direct contact with the skin of the user 30. However, when desired, the inner layer 101 can still be close to the skin of the user 30, but separated therefrom by a fabric of an undergarment (not shown). In such a case, the undergarment cloth can, for example, be made of foraminated and/or wicking fabric to permit convey of the perspiration both in the vapor and liquid state therethrough.

The undergarment cloth can also have hydrophobic characteristics. In such a case, the undergarment will not absorb the perspiration from the skin of the user 30. Thus, the perspiration will be conveyed to the inner layer 101. An example of the material suitable for the undergarment includes, but is not limited to, CoolMax™ material.

According to the embodiment shown in FIG. 2E, the inner layer 101 is also foraminated by pores to permit conveyance of the perspiration therethrough, and has hydrophobic characteristics. For example, the inner layer 101 can be composed of synthetic fibers such as polyester, polyolefin, Gortex™ or CoolMax™ fibers having low moisture content.

According to this embodiment of the invention, the air delivery layer 103 has hydrophilic characteristics and can absorb perspiration. For example, the air delivery layer 103 can be composed of moisture absorbing natural fibers such as cotton or wool, or synthetic fibers such as Dacron™ fibers. Also, synthetic fine spun fibers, which are highly absorbent, may be used for this purpose. According to the invention, the air delivery layer 103 contains a plurality of vent openings 29 providing an air communication between the first spacer layer 104 and the second spacer layer 105.

When desired, the outer layer 102 can have thermal insulating characteristics to protect the user 30 from external weather conditions, for example by reducing the effect of solar heating the body of the user. For example, the outer layer 102 can be made of fleece or Neoprene materials or fleece materials mixed with an appropriate phase change material (PCM). PCM is a safe chemical which changes phase inside a heatsink at an appropriate temperature, thus absorbing or releasing latent heat.

The use of PCM for thermal insulation purpose is known per se. In particular, in the same way that ice in a water/ice mixture prevents the water from rising much above 4° C. until all the ice is melted, PCM prevents the thermal insulating layer, and thus the enclosure, rising much above its melting point until the solid phase is exhausted. PCM solidifies for reuse once the temperature drops. Examples of PCM suitable for the purpose of the present invention include, but are not limited to, paraffin, wax, etc.

When required, an external surface 17 of the outer layer 102 can be coated with a reflection material to reflect ambient electromagnetic radiation impinging on this layer. The coating can, for example, be performed by sputtering an extremely thin metal coating and/or reflective polymeric dye over the external surface 17 of the outer layer 102.

When required, the outer layer 102 can include a solar radiation reflecting dye in order to protect the user 30 from external solar radiation, by reducing the heating effect of the solar radiation on the exposed outer layer. A technology for preparing the outer layer 102 for this embodiment can, for example, be based on the TFL COOL SYSTEM™ technology.

According to an embodiment, the first spacer layer 104 and the second spacer layer 105 are formed from a plastic skeleton in the form of a 3D grate. According to another embodiment, the first spacer layer 104 and the second spacer layer 105 are formed from a highly porous percolating material. The purpose of the first and second spacer layers is to permit air ventilation and avoid collapse of the space of the ventilation chambers V1 and V2. An example of the materials suitable for the spacer layers 104 and 105 includes, but is not limited to, 3D nylon mesh.

According to the embodiment shown in FIG. 2E, the first ventilation chamber V1 is coupled to a hose adapter 106 via openings 121a and 121b arranged at a bottom 107 of the ventilation section 10. The hose adapter 106 is configured for receiving an ingress air stream (shown by arrows) provided by an air moving device 2 coupled thereto. Preferably, but not mandatory, the hose adapter 106 is in the form of a fork manifold having one inlet 18 and two outlets 19a and 19b. The outlets 19a and 19b are coupled to the first ventilation chamber V1 at the frontal part 12 and the rear part 13 of the item of apparel 11 through the openings 121a and 121b, respectively. The inlet 18 is preferably arranged with a universal connector 20 enabling the hose adapter 106 to be connected to various kinds of air moving devices. Preferably, but not mandatory, the air conditioning hose adapter 106 is equipped with an air deflector 28 adapted to change proportion of the air distributed between the frontal and rear parts 12 and 13.

Because the first ventilation section V1 is sealed, the ingress air stream (shown by arrows) entering the first ventilation section V1 is forced to pass into the second ventilation section V2 through the vent openings 29 of the air delivery layer 103.

It is well known to a person versed in the art that maintaining the desired body temperature in hot climate conditions, can be achieved not only by cooling the body by using precooled air, but also by facilitating the natural perspiration process, as will be described hereinbelow. Thus, depending upon the particular climate in which the garment is used, cooling of the air in the air flow stream may not be required. In such a case, the air moving device 2 can be a conventional mini-fan, blower, impeller, or like device operable to bring air from the outside environment into the first ventilation section V1 of the garment without preliminary cooling.

Because the fibers of the inner layer 101 are hydrophobic, they do not absorb perspiration from the skin of the wearer, but are permeable to such perspiration and act, therefore, to convey the perspiration both in the vapor and liquid state to the first spacer layer 104. Thereafter, the perspiration is conveyed further through the percolating pores (not shown) of the first spacer layer 104 towards the air delivery layer 103. The air stream passing through the first spacer layer 104 further facilitates the transport of perspiration to the air delivery layer 103. As a result, the vapor and moisture resulting from perspiration on the skin of the user are conveyed to the air delivery layer 103 and are absorbed thereby. The moisture absorbed in the air delivery layer 103 is more or less uniformly dispersed throughout this layer. Consequently, even though a given body zone exudes far more perspiration than another body region covered by the same garment, the resultant moisture is not concentrated in the garment area lying against this zone, but is dispersed throughout the garment over a relatively broad area.

Due to air communication between the first ventilation section V1 and the second ventilation section V2, the air flow stream passing through the vent openings 29 can dry the air delivery layer 103 and convey the results of the perspiration to the second spacer layer 105. The second spacer layer 105 has openings 109 at its top 108 and/or bottom 107, to provide a release of an egress air stream (carrying the result of the perspiration) into the environment.

It should be understood by a person versed in the art that drying of the air delivery layer 103 is an endothermic process that inter alia promotes evaporative cooling of the body. Such evaporative cooling may be especially important when the air stream is created by such air moving device as a mini-fan, blower, impeller and like, which brings the ambient air from the outside environment without preliminary cooling.

According to an embodiment of the invention, the egress air stream leaving the item of apparel 11 from the ventilation chambers can be used as an ingress air stream to feed the air moving device 2. Such circulation of the air stream within the air-conditioning system can provide a more economic regime of operation of the air moving device 2.

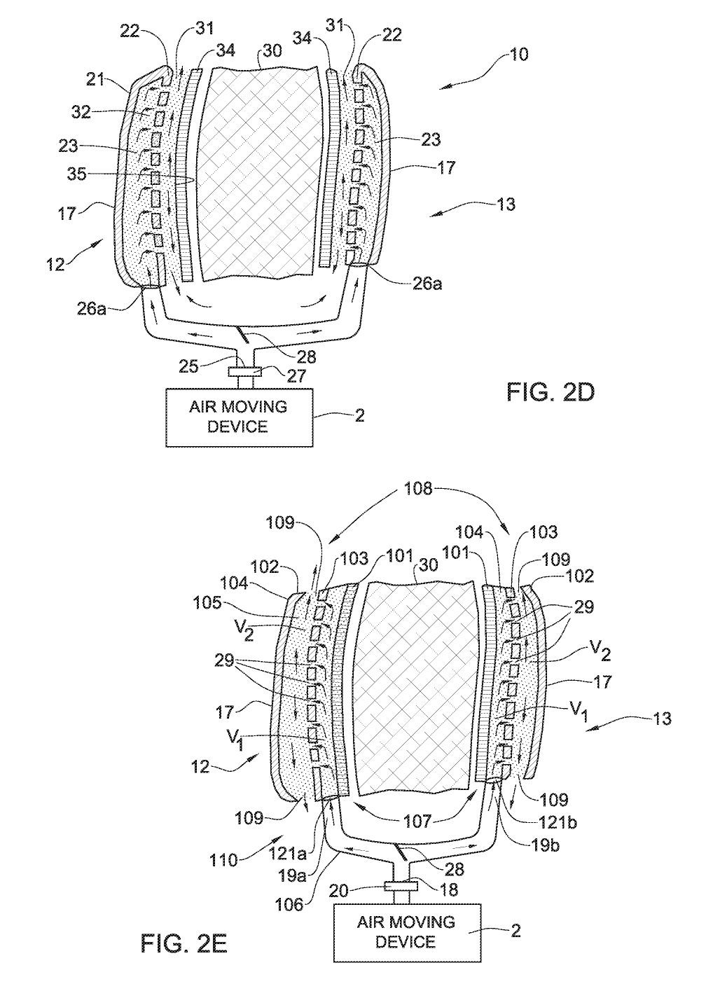

Turning now to FIGS. 3A and 3B, a general schematic view a personal air-conditioning cooling system is illustrated, according to other embodiments of the present invention. According to these embodiments, the egress air stream leaving the ventilation chambers of the item of apparel 11 can be used as an ingress air stream for other items of apparel or devices. It should be noted that only relevant components of the system for the description of a multi-piece air-conditioning system are shown in FIGS. 3A and 3B.

As shown in FIG. 3A, the egress air flow at the top 51 of the vest can be used as an ingress air stream for a headwear 52, while the egress air flow at the bottom 53 of the vest can be used as an ingress air flow for trousers 54, mutatis mutandis.

As shown in FIG. 3B, the egress air stream leaving the air moving unit can also provide an air stream to another item of apparel 61 that provides an air stream to the neck 62, face 63, and/or head 64 of the user, thereby elevating heat/cool load on the neck 62 face 63, head 64 and breathing organs (not shown). According to the embodiment shown in FIG. 3B, the flexible air delivery device 61 is in the form of a collar having a plurality of vent openings that deliver cool/hot air stream to physiologically relevant areas of the neck, face and/or head. Such a combination of the convection, evaporation and breathing thermoregulation mechanisms could provide a most effective subjective feeling of well-being of the user, and will objectively benefit the thermoregulation characteristics of the user.

When required, the egress air stream leaving the item of apparel 11 from the ventilation chambers can be used as an ingress air stream for the item of apparel 61 that provides an air stream to the neck 62, face 63, and/or head 64 of the user.

When required, the flexible air delivery device 61 can include a sealed mask (not shown), e.g., NBC (nuclear biological and chemical) mask, or act as an adapter to a NBC mask, providing a possibility to the user to inhale the air conditioned air stream. Such a combination of convection, evaporation and breathing thermoregulation mechanisms could provide a most effective subjective feeling of well-being of the user, and will objectively benefit the thermoregulation characteristics of the user.

When required, the personal air-conditioning system can further include an air filter (not shown) arranged in a predetermined place along the pass of the ingress air stream, and configured for filtering the ambient air from pollutions, toxins, poisons, etc.

It should be understood that the configuration and operation of the flexible ventilation section 10 described above with reference to FIGS. 2A-2E for the item of apparel 11 can also suitable for flexible ventilation section 700 arranged within upholstery (76 in FIG. 7) of a vehicle seat, mutatis mutandis.

Turning back to FIG. 7, the most inner layer (e.g., inner layer 34 in FIG. 2D and 101 in FIG. 2E) can be in a direct contact with the user. In the example illustrated in FIG. 7, section 700 fits onto the vehicle seat 711 and the user's body is in contact with the innermost layer, whereas the outermost layer (e.g., outer layer 17 in FIG. 2D and 102 in FIG. 2E) is in contact with the seat.

According to an embodiment, the flexible ventilation section 700 can include several pieces being in airflow communication. Specifically, a section 706 is the main part of the ventilation section 700 that provides airflow to the user's back (not shown). Sections 704 and 705 are additional flaps that provide airflow to side and front parts of the user's body (not shown). Sections 710, 702 and 703 provide airflow to the area of the head of the user.

As shown in FIG. 7, at least one of the side sections 704 and 705 of the flexible ventilation section 700 is connected to a vehicle safety belt 80, for example via a fastener 709, so that, when fastening the belt, the side section 705 may cover the front part of the user's body.

Depending on the ambient environment, operation of the air-conditioning system of the present invention can be carried out in various operation modes. Monitoring human reactions to hot and cold ambient environments by the Applicant of the present application has led to several observations:

Firstly, there is a distinction between the physiological objective state of the user and the subjective perception of the well-being of the user, the latter being rather a psychological effect. The brain perceives mainly changes in the microclimate surrounding the body, and not necessarily the actual physiological state. The Applicant exploits this feature of brain perception and use different methods in order to better regulate the thermal balance of the user's body via a physiologically correct body suit associated with the personal air-conditioning system. The operation modes of the personal air-conditioning system enable manipulation of the perception of the brain by using invented control mechanisms that modulate the predetermined parameters of the air-moving device.

Secondly, it was noted that after a long stay in comfortable temperature conditions, the person (placed in hot or cold conditions) begins to feel uncomfortable not immediately after replacing of the conditions, but rather only after a certain time period. Such a “memory” effect of the human reaction on changing the temperature conditions has been exploited by the Applicants for effectively operating an air conditioner device that provides a cool/warm air stream to the ventilation section of the garment of the personal air-conditioning system.

According to the invention, the method of operating an air moving device depends, inter alia, on the type of the air moving device utilized. The method of operating the air-conditioning system of the invention, inter alia, includes controllable activating of a predetermined control algorithm that automatically alternates one or more predetermined parameters of the air moving device in accordance with a predetermined time dependent operation pattern. When a sanitary module 45 is employed, the method also includes activating a predetermined control algorithm for activating the sanitary module when required.

For example, operation of the air-conditioning system can be in a cyclic regime, and the sanitary module can be activated during any cycle of the cyclic regime.

According to an embodiment of the invention, the operation pattern can include predetermined automatic operation regimes (i.e. modes) that are implemented when manual operation of the system is used. In operation, the control algorithm can effect a pulse of highly cooled air stream followed by a lower cooled air stream. Likewise, when required, the operation pattern can include oscillations of cooling and heating operational regimes and/or oscillations of the rate of air flow.

Likewise, the operation pattern can be based on a closed loop control implementation.

According to another embodiment of the invention, the method of operating the air moving device depends on the physiological characteristics measured by the sensing devices (4 in FIG. 1). According to this embodiment, the method of operating an air moving device includes measuring one or more physiological characteristics of a user of the personal air-conditioning system and/or ambient parameters, thereby to produce sensor signals indicative thereof. Thereafter, the method includes analyzing the sensor signals on the basis of a physiological model of human thermoregulation mechanisms and generating control signals required for the controlling of operation of the air moving device.

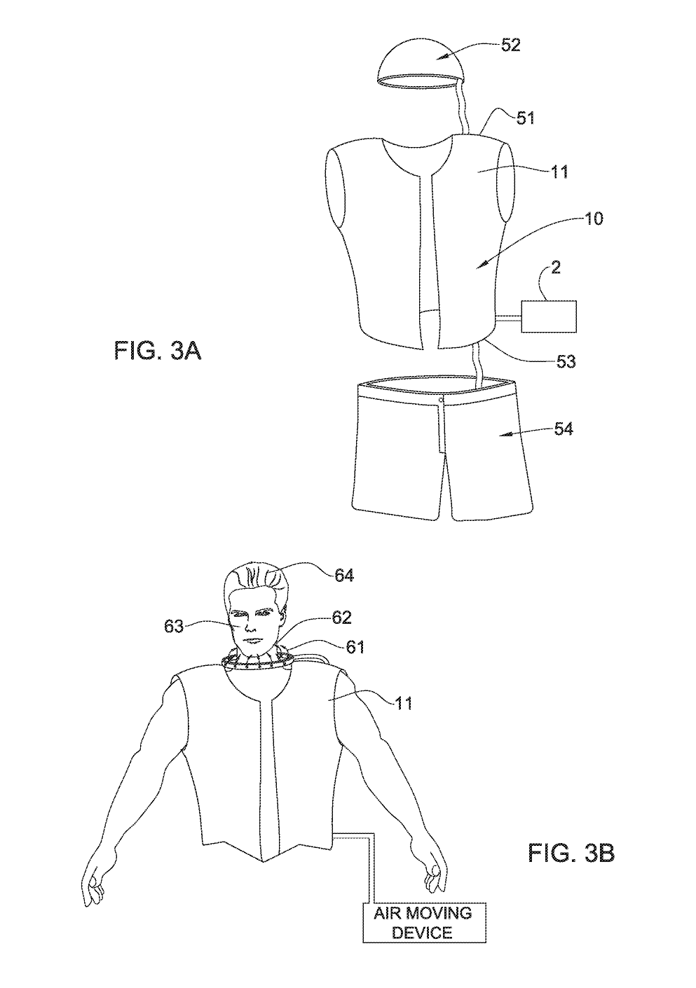

Turning now to FIGS. 4A and 4B, schematic diagrams of air delivery rate and temperature exemplary waveforms used for operating an air moving device (2 in FIG. 1) in effective cooling and heating regimes are illustrated, according to some embodiments of the present invention. These embodiments are contemplated for the air moving device including an air conditioner device.

The air conditioner device can be of any known type, for example, the thermoelectric air conditioner device described in U.S. Pat. No. 6,510,696 assigned to the Applicant of the present Application.

All air conditioner devices include heat exchangers (heat sink) and at least one blower configured for forcing air flow to flow through the heat exchangers. It is known that the temperature of the heat exchangers depends on the air delivery rate. For example, in heating mode, the higher the air delivery rate, the lower the temperature of the heated heat exchanger, because the higher value of heat energy is taken therefrom. In turn, in cooling mode, the lowest temperature of the cooled heat exchanger can be achieved in idle regime of the air conditioner device, i.e., when the heat exchangers are cooled, but the blower of the air conditioner device does not operate to create air flow for passing through the heat exchangers.

According to an embodiment, in cooling mode (see FIG. 4A), when the air conditioner device is switched on, the blower of the air conditioner starts to operate in an interruption manner over a predetermined transition time period in order to cool the heat exchangers from the ambient air temperature to their lowest temperature T_{low}, and thereby gradually decrease the temperature of the air stream. The gradual decrease of the temperature without cold shock over the predetermined transition time period can be required for comfortable adaptation of the user to the cool air provided by the air conditioner.

As soon as the temperature of the heat exchangers reaches the lowest value T_{low}, the blower of the air conditioner device starts to operate in a cyclic manner

For example, the blower of the air conditioner device can operate in a sequence of three regimes that can be repeated in a cyclic manner. In the beginning, the blower starts to operate at high power regime (at the time moment to), thus providing a cool air stream characterized by a high value Vₘ of the air delivery rate. This regime (first cyclic regime) continues over a certain time period [t₀; t₁] during which the temperature of the cool air stream elevates to a predetermined maximal value Tₘ. Then, at the time moment ti the blower starts to operate at a predetermined air delivery power regime (second cyclic regime) characterized by an air delivery value Vₘ of the air delivery rate. The magnitude of Vₘ is selected such so that the temperature of the air flow stream starts to decrease. This regime continues over a certain time period [t₁i; t₂] during which the temperature of the cool air stream drops to a predetermined value Tₘ. Thereafter, the blower stops to operate over a certain relatively short time period [t₂; t₃] (third cyclic regime). The duration of this idle regime of operation of the air conditioner is such so that the temperature of the heat exchangers could drop back to its lowest value T_{low}. Because time period [t₂; t₃] is relatively short, the user will not begin to feel overheated over this time period, due to the described above perception effect of the human reaction on the hot ambient air and the heat capacity of the heat exchangers.

Thereafter, the sequence of the described above three regimes can be repeated as long as desired.

For example, when the air conditioner device described in U.S. Pat. No. 6,510,696 is used for cooling a user placed in a hot outside environment with the ambient air temperature of about 35° C., the operating parameters can be set to the following values: the interval [t₀; t₁] can be in the range of about 0.5 minutes to 5 minutes, preferably about 1 minute; the interval [t₁; t₂] can be in the range of about 15 seconds to 3 minutes, preferably about 30 seconds; the interval [t₂; t₃] can be in the range of about 5 seconds to 1 minute, preferably about 15 seconds; the predetermined transition time period can be in the range of about 5 minutes to 15 minutes, preferably about 10 minutes; the predetermined lowest temperature T_{low} is about 25° C.; the predetermined maximal temperature Tₘ is about 28° C.; and the predetermined value Tᵢₙ is about 26° C.

In heating mode (see FIG. 4B), when the air conditioner device is switched on, the blower of the air conditioner starts to operate in an interruption manner over a predetermined transition time period in order to heat the heat exchangers from the ambient air temperature to their highest temperature Tₕ, and thereby gradually elevate the temperature of the air stream. The gradual elevation of the temperature without hot shock over the predetermined transition time period can be required for comfortable adaptation of the user to the hot air provided by the air conditioner.

As soon as the temperature of the heat exchangers reaches the highest value Tₕ, the blower of the air conditioner device starts to operate in a cyclic manner in three regimes. In the beginning, the blower starts to operate at high power regime (at the time moment to), thus providing a hot air flow stream characterized by a high value Vₘ of the air delivery rate. This regime (first cyclic regime) continues over a certain time period [t₀; t₁] during which the temperature of the hot air stream drops to a predetermined minimal value Tₘᵢₙ.

Then, at the time moment ti the blower starts to operate at a predetermined air delivery power regime (second cyclic regime) characterized by an air delivery value Vᵢₙ of the air delivery rate. The magnitude of Vᵢₙ is selected such that the temperature of the air flow stream starts to elevate. This regime continues over a certain time period [t₁i; t₂] during which the temperature of the hot air stream elevates up to a predetermined value Tₘ.

Thereafter, the blower stops to activate over a certain relatively short time period [t₂; t₃] (third cyclic regime). The duration of this idle regime of operation of the air conditioner is such that the temperature of the heat exchangers may elevate back to its highest value Tₕ. Because time period [t₂; t₃] is relatively short, the user will not begin to feel cold over this time period, due to the described above perception effect of the human reaction on the ambient air and the heat capacity of the heat exchangers.

Thereafter, the sequence of the described above three regimes can be repeated as long as desired.

For example, when the air conditioner device described in U.S. Pat. No. 6,510,696 is used for heating a user placed in a cold outside environment with an ambient air temperature of about 0° C., the operating parameters can be set the following values: the interval [t₀; t₁] can be in the range of about 1 minute to 8 minutes, preferably about 3 minutes; the interval [t₁; t₂] can be in the range of about 30 seconds to 3 minutes, preferably about 1 minute; the interval [t₂; t₃] can be in the range of about 15 seconds to 1 minute, preferably about 30 seconds; the predetermined transition time period can be in the range of about 5 minutes to 15 minutes, preferably about 10 minutes; the predetermined highest temperature Tₕ is about 30° C.; the predetermined minimal temperature Tₘᵢₙ is about 25° C.; and the predetermined value Tᵢₙ is about 27° C.

It should be noted that an example of the time dependent operation in the form of an interruption manner of the operation of the air conditioner device over a predetermined transition time period includes, but is not limited to the described above cyclic regime of the air conditioner. The time dependent operation pattern can include pulses, oscillations or any other time dependent pattern of any of the predetermined operation parameters of the air moving device and/or sanitary capsule module.

It should be understood that the present invention is not bound by the three cyclic regimes of operating the air-conditioning system of the present invention. Thus, the number of the cyclic regimes can be changed, in accordance with the requirements of the user.

Generally, depending on the measured ambient parameters of the environment, measured physiological characteristics and subjective feelings of the user, any available predetermined parameter of the air stream parameters, such as temperature of the air stream, humidity of the air stream, and air delivery rate along with sanitary capsule module, can be controllably varied during operation of the air conditioner device according to a predetermined time dependent pattern on the basis of the physiological model of the thermoregulation mechanism.

Moreover, although the examples of operating an air moving device presented above are illustrated for operating an air conditioner device, it should be understood that the concept of modulation of predetermined parameters described in the invention can be applied to operating any other air moving device (e.g., mini-fan, blower, impeller, etc.) as well, mutatis mutandis.

It should be understood that a conventional continuous blowing regime, in which the air stream produced by the air moving device has a constant temperature, can also be employed without derogation of the invention.

As such, those skilled in the art to which the present invention pertains, can appreciate that while the present invention has been described in terms of preferred embodiments, the conception, upon which this disclosure is based, may readily be utilized as a basis for the designing of other structures systems and processes for carrying out the several purposes of the present invention.

For example, the flexible ventilation section (10 in FIGS. 2A-2E and 700 in FIG. 7) can include a heating layer (not shown) arranged between the outer layer and the inner layer of the flexible ventilation section. The heating layer can, for example, include a grid of resistive wires that can heat as a result of driving an electric current therethrough. In operation, the ventilation air driven from the air moving device and passing through the flexible ventilation section can be heated by the grid of resistive wires and then be provided to the user's body.

It is to be understood that the phraseology and terminology employed herein are for the purpose of description and should not be regarded as limiting.

It is important, therefore, that the scope of the invention is not construed as being limited by the illustrative embodiments set forth herein. Other variations are possible within the scope of the present invention as defined in the appended claims. Other combinations and sub-combinations of features, functions, elements and/or properties may be claimed through amendment of the present claims or presentation of new claims in this or a related application. Such amended or new claims, whether they are directed to different combinations or directed to the same combinations, whether different, broader, narrower or equal in scope to the original claims, are also regarded as included within the subject matter of the present description.

1-44. (canceled)

45. A personal air-conditioning system comprising:
an air moving device operable to provide an air stream characterized by at least one predetermined air stream parameter;
a flexible ventilation section being in air flow communication with said air moving device and configured to provide the air stream to a user of the personal air-conditioning system, said flexible ventilation section being in the form of a multi-layered structure comprising:
an outer layer made of a dense material to prevent penetration of the air stream therethrough, and
an air delivery layer containing a plurality of vent openings distributed within at least a portion of the air delivery layer so as to provide the air stream optimally to physiologically sensitive areas of a body of the user through said plurality of vent openings,
wherein said outer layer and said air deliver layer are bound to each other along their borders to define a ventilation chamber therebetween, said ventilation chamber being in air flow communication with said air moving device; and a control unit coupled to said air moving device for controlling operation thereof by regulating said at least one predetermined air stream parameter.

46. A personal air-conditioning system of claim 45, wherein said control unit comprises:
sensing devices configured for (i) measuring at least one sensing parameter selected from physiological characteristics of a user of the air-conditioning system, ambient parameters, a vehicle battery charge, vehicle main switch state, and presence of a user in the vicinity of the personal air-conditioning system; and (ii) producing at least one sensor signal indicative of said at least one sensing parameter; and
a computer unit coupled to said sensing devices and configured for analyzing said at least one sensor signal and generating at least one control signal required for said controlling of the operation of the air moving device.

47. The personal air-conditioning system of claim 45, wherein said air moving device is an air conditioner device and said at least one predetermined air stream parameter is selected from temperature of the air stream, humidity of the air stream and air delivery rate.

48. The personal air-conditioning system of claim 45, wherein said air moving device is selected from a mini-fan, blower and impeller, and said at least one predetermined air stream parameter is air delivery rate of the air stream.

49. The personal air-conditioning system of claim 46, wherein said physiological characteristics of the user are selected from temperature of the skin, perspiration of the user, blood pressure of the user, pulse rate of the user, brain activity of the user, and heart activity of the user.

50. The personal air-conditioning system of claim 46, wherein said ambient parameters are selected from ambient temperature, ambient humidity, ambient wind speed and ambient sun radiation.

51. The personal air-conditioning system of claim 46, wherein said sensing device comprises at least one device selected from:
an electric thermometer coupled configured for measuring said temperature of the skin and producing a temperature sensor signal;
a humidity sensor configured for sensing said perspiration of the user and producing a humidity sensor signal;
a blood pressure sensor configured for measuring said blood pressure of the user and producing a blood pressure sensor signal;
a pulse sensor configured for measuring said pulse rate of the user and producing a pulse sensor signal;
an electrocardiogram (ECG) sensor configured for determining said heart activity and producing an ECG sensor signal, an electroencephalogram (EEG) sensor for determining said brain activity and producing an EEG sensor signal,
wherein said computer unit comprises a processor being responsive to said at least one sensor signal selected from said temperature sensor signal, said humidity sensor signal, said blood pressure sensor signal, said pulse sensor signal, said ECG sensor signal, said EEG sensor signal; and
configured for providing said at least one control signal.

52. The personal air-conditioning system of claim 46, wherein said sensing devices comprises at least one device being exposed to the environment and selected from:
an external electric thermometer configured for measuring the ambient temperature and producing an ambient temperature sensor signal representative of the ambient temperature;
an ambient humidity sensor configured for sensing ambient humidity and producing an ambient humidity sensor signal;
wind flow meter configured for sensing ambient wind speed and producing a wind flow sensor signal; and
sun radiation sensor configured for sensing sun radiation and producing a sun radiation sensor signal;
wherein said computer unit comprises a processor being responsive to said at least one sensor signal selected from said ambient temperature sensor signal, said ambient humidity sensor signal, said wind flow sensor signal and said sun radiation sensor signal; and
configured for providing said at least one control signal.

53. The personal air-conditioning system of claim 46, wherein said sensing devices comprises at least one sensor device mounted in a vehicle and selected from a battery charge sensor, vehicle main switch state sensor, and a proximity sensor;
said vehicle main switch state sensor is configured to register the operation vehicle state;
said proximity sensor is configured to register a presence of the user in the vicinity of the personal air-conditioning system and generate a proximity sensor signal.

54. The personal air-conditioning system of claim 46, further comprising a heater arranged downstream of said air moving device, and being responsive to said at least one control signal for controllable heating said air stream.

55. The personal air-conditioning system of claim 46, further comprising a sanitary module arranged upstream of said flexible ventilation section, said sanitary module including a capsule containing a predetermined pharmaceutical and/or fragrance composition, said sanitary module is responsive to said at least one control signal for controllable dispensing said predetermined pharmaceutical and/or fragrance composition into said air stream to benefit the user of the system.

56. The personal air-conditioning system of claim 46, wherein said control unit includes:
a user transmitter arranged at the end of the user of the personal air-conditioning system, the user transmitter is configured for transmitting said at least one sensor signal to a remote operator,
an operator receiver arranged at the end of the remote operator, the operator receiver is configured to receive said at least one sensor signal and provide said at least one sensing parameter represented thereby to the remote operator;
an operator transmitter arranged at the end of the remote operator, the operator transmitter is configured for transmitting a remote operator control signal provided by the remote operator; and
a user receiver arranged at the end of the user of the personal air-conditioning system, the user receiver is configured for receiving said remote operator control signal and relaying it to said computer unit;
wherein said computer unit is also coupled to said user receiver, and configured for analyzing said remote operator control signal for generating said at least one control signal, thereby to operate said control unit in an open loop control mode.

57. The personal air-conditioning system of claim 45, wherein air communication between said flexible ventilation and said air moving device is established via a hose adapter having an inlet and at least one outlet, where the inlet is coupled to said air conditioner device, and said at least one outlet is coupled to said flexible ventilation section.

58. The personal air-conditioning system of claim 45, wherein a density of distribution of said plurality of vent openings increases with the distance from an air ingress inlet.

59. The personal air-conditioning system of claim 45, wherein a density of distribution of said plurality of vent openings is higher near physiological important areas selected from armpits and neck region of the user.

60. The personal air-conditioning system of claim 45, wherein said flexible ventilation section further includes a first spacer layer adjacent to the inner surface of said air delivery layer, and a second spacer layer sandwiched between said outer layer and said air delivery layer, so as to provide homogeneous distribution of the air stream and prevent collapse of the space between the garment and the body of the user.

61. The personal air-conditioning system of claim 60, wherein said flexible ventilation section further includes an inner layer adjacent to said first spacer layer from the inner surface thereof configured to provide at least one of the following:
extraction and conveyance of perspiration exuded from the user's skin therethrough and reducing direct airflow to the body in sensitive areas.

62. The personal air-conditioning system of claim 61, wherein said inner layer has hydrophobic characteristics and is formed from a foraminated material to permit ventilation of air and convey perspiration exuded by a user of said garment therethrough.

63. The personal air-conditioning system of claim 45, wherein said outer layer is made of a material comprising a phase change material.

64. The personal air-conditioning system of claim 45, wherein said outer layer is covered with a reflective coating formed on external surface thereof and adapted to reflect ambient electromagnetic radiation impinging thereon.

65. The personal air-conditioning system of claim 45, further comprising at least one other flexible ventilation section, the system wherein an egress air stream leaving said flexible ventilation section is used as an ingress air stream for said at least other flexible ventilation section.

66. The personal air-conditioning system of claim 45, wherein an egress air stream leaving the ventilation chamber is used as an ingress air stream to feed the air moving device, thereby to provide circulation of the air stream within said personal air-conditioning system.

67. The personal air-conditioning system of claim 45, wherein said ventilation chamber is integrated with a portion of an item of apparel having a frontal part and a rear part.

68. The personal air-conditioning system of claim 57, wherein said hose adapter is in the form of a fork manifold having two outlets coupled to said flexible ventilation section at the frontal and rear parts of the item of apparel, correspondingly,
wherein said hose adapter comprises an air deflector adapted to change proportion of the air distributed between the frontal and rear parts of said item of apparel.

69. The personal air-conditioning system of claim 45, wherein said ventilation chamber is integrated with at least a portion of upholstery of a vehicle seat.

70. A method of operating the personal air-conditioning system of claim 46, the method comprising:
measuring said at least one sensing parameter selected from physiological characteristics of the user of said personal air-conditioning system, ambient parameters, a parameter characterizing a presence of the user in the vicinity of the air-conditioning system, and vehicles parameters;
generating said at least one sensor signal indicative of said at least one sensing parameter;
analyzing said at least one sensor signal and generating at least one control signal required for said controlling of the operation of the air moving device.

71. A method of operating the system of claim 55, the method comprising:
measuring said at least one sensing parameter selected from physiological characteristics of the user of said item of apparel and ambient parameters;
generating said at least one sensor signal indicative of said at least one sensing parameter; and
analyzing said at least one sensor signal and generating at least one control signal required for said controlling of the operation of the sanitary capsule module.

72. The method of claim 70, wherein said at least one control signal is configured for activating a predetermined algorithm for controllably alternating said at least one predetermined air stream parameter in accordance with a predetermined time dependent operation pattern.

73. The method of claim 72, wherein said controlling of the operation of the air moving device includes cyclically activating an idle regime of the operation of the air moving device.

74. The method of claim 73, wherein said controlling of the operation of the air moving device includes operating the air moving device in a sequence of three cyclic regimes, where a first cyclic regime is characterized by a high value of the air delivery rate, a second cyclic regime is characterized by an air delivery value of the air delivery rate, and a third cyclic regime is an idle regime.

75. The method of claim 74, wherein said personal air-conditioning system operates in cooling mode, and said first cyclic regime continues over a time range of about 0.5 minutes to 5 minutes, said second cyclic regime continues over a time range of 15 seconds to 3 minutes, and said idle regime continues over a time range of 5 seconds to 1 minute.

76. The method of claim 74, wherein said personal air-conditioning system operates in heating mode, and said first cyclic regime continues over a time range of about 1 minutes to 8 minutes, said second cyclic regime continues over a time range of 30 seconds to 3 minutes, and said idle regime continues over a time range of 15 seconds to 1 minute.
